(19) United States
(12) Patent Application Publication
(10) Pub. No.: US 2010/0272251 A1
(43) Pub. Date: Oct. 28, 2010

(54) ECHO REMOVING APPARATUS, ECHO REMOVING METHOD, AND COMMUNICATION APPARATUS

(75) Inventors: Tatsushi BANBA, Tokyo (JP); Hiroshi Yamashita, Kanagawa (JP); Hidetoshi Ichioka, Tokyo (JP); Kazuo Nishiyama, Kanagawa (JP); Shiro Omori, Kanagawa (JP); Kenji Suzuki, Tokyo (JP); Shuichi Takizawa, Chiba (JP); Shinichi Sameshima, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/751,003

(22) Filed: Mar. 31, 2010

(30) Foreign Application Priority Data
Apr. 28, 2009 (JP) 2009-108950

(51) Int. Cl. H04M 9/08

(52) U.S. Cl. 379/406.08

(57) ABSTRACT

Disclosed herein is an echo removing apparatus including: a sound input terminal configured to input an external sound signal from external equipment; a first echo removing device configured to, after admitting as input signals the external sound signal coming from the external equipment and input through the sound input terminal and a receiver sound signal transmitted from a calling party, estimate a first pseudo echo component from the external sound signal in order to remove the first pseudo echo component from the receiver sound signal; and a second echo removing device configured to, after admitting as input signals the external sound signal coming from the external equipment and input through the sound input terminal and a transmitter sound signal input from a microphone, estimate a second pseudo echo component from the external sound signal in order to remove the second pseudo echo component from the transmitter sound signal.

### BACKGROUND OF THE INVENTION

1. Field of the Invention

The present invention relates to an echo removing apparatus, an echo removing method, and a communication apparatus.

2. Description of the Related Art

Recent years have witnessed widespread commercialization of so-called speakerphone communication systems such as hands-free communication systems derived from telephones as well as videophones.

Where these systems are in use, the speaker of one calling party's communication apparatus first outputs the other calling party's voice coming from the latter's communication apparatus. The other calling party's voice being output by the speaker of one calling party's communication apparatus is again picked up by the microphone of the latter's communication apparatus and sent to the other calling party's communication apparatus. In turn, the speaker of the other calling party's communication apparatus outputs the other calling party's voice having been picked up on the opposite side. When this process is repeated, each calling party may hear not only the other party's voice but also his or her own voice being repeated by the system in a phenomenon called echo. When generated in this manner, echoes can lower the quality of voice communication and hamper smooth conversations between the two calling parties.

In order to prevent echoes, communication apparatuses such as videophone terminals are generally equipped with a so-called echo canceller each.

As shown in FIG. 6, a telephone terminal 600 furnished with an ordinary echo canceller 601 includes a speaker 602 and a microphone 603. The echo canceller 601 is made up of an adaptive filter 601A and a subtractor 601B.

A receiver sound signal S61 sent from the other calling party is input to the adaptive filter 601A of the echo canceller 601. Based on the receiver sound signal S61, the adaptive filter 601A generates a pseudo echo signal E61 estimating the echo component migrating from the speaker 602 to the microphone 603. The pseudo echo signal E61 thus generated is input to the subtractor 601B. Also input to the subtractor 601B is a transmitter sound signal S62 converted from the mixture of the calling party's voice input to the microphone 603 and of the receiver sound migrating from the speaker 602 to the microphone 603.

The subtractor 601B removes the echo component from the transmitter sound signal S62 by subtracting the pseudo echo signal E61 from the transmitter sound signal S62. The subtractor 601B thus obtains a transmitter sound signal S63 that is output. At this point, the transmitter sound signal S63 is input to the adaptive filter 601A as a remainder signal. The adaptive filter 601A learns to minimize the remainder represented by the remainder signal and updates its own filter coefficient accordingly, thereby generating an ever-more appropriate pseudo echo signal E61.

A typical videophone system using the echo canceller outlined above is disclosed in Japanese Patent Laid-open No. 2007-214976.

### SUMMARY OF THE INVENTION

As shown in FIG. 7, the videophone system is constituted illustratively by one calling party's videophone terminal equipment installed at a location A and the other calling party's videophone terminal equipment at a location B. The videophone terminal equipment used by one calling party at the location A is made up of a telephone terminal 600 furnished with the ordinary echo canceller 601 and a TV set 700 of which the enclosure is separated from the telephone terminal 600. The videophone terminal equipment used by the other calling party at the location B is composed of a telephone terminal 800 and a TV set 900 of which the enclosure is separated from the telephone terminal 800. One calling party's telephone terminal 600 and the other calling party's telephone terminal 800 are connected via the Internet so as to implement videophone communication therebetween. It is assumed that the two calling parties, while holding a conversation, are watching the same TV program on their respective TV sets 700 and 900.

As shown in FIG. 7, where the TV set 700 is set up in the same space as the microphone 603, the TV sound output from a TV speaker 701 is picked up by the microphone 603. This entails transmitting a sound mixture of one calling party's voice and the TV sound on the side of this calling party to the other calling party. In turn, a receiver speaker 801 of the other calling party outputs both one calling party's voice and the TV sound on the side of this party. If the two calling parties are simultaneously watching the same TV program, an echo phenomenon occurs between the TV sound output from the receiver speaker 801 of one calling party on the one hand, and the TV sound output from a TV speaker 901 of the other calling party on the other hand, whereby the conversation between the two parties can be disrupted. Similarly, one calling party's receiver speaker 602 outputs as the receiver sound both the other calling party's voice and the TV sound output from the TV speaker 901 of the other calling party. This can further disrupt the conversation between the two parties. Since the ordinary echo canceller shown in FIG. 6 is designed only to prevent echoes of the calling parties' voices in conversations, the echo canceller cannot prevent the occurrence of echoes of the same TV sound emanating from the two parties as described above.

The present invention has been made in view of the above circumstances and provides an echo removing apparatus, an echo removing method, and a communication apparatus for preventing the generation of echoes where the same sound is being output near both calling parties' communication apparatuses, such as when the two parties are watching the same TV program during their conversation.

In carrying out the present invention and according to one embodiment thereof, there is provided an echo removing apparatus including: a sound input terminal configured to input an external sound signal from external equipment. The echo removing apparatus further includes: a first echo removing device configured such that after admitting as input signals the external sound signal coming from the external equipment and input through the sound input terminal and a receiver sound signal transmitted from a calling party, the first echo removing device estimates a first pseudo echo component from the external sound signal in order to remove the first pseudo echo component from the receiver sound signal; and a second echo removing device configured such that after admitting as input signals the external sound signal coming from the external equipment and input through the sound input terminal and a transmitter sound signal input from a microphone, the second echo removing device estimates a second pseudo echo component from the external sound signal in order to remove the second pseudo echo component from the transmitter sound signal.

According to another embodiment of the present invention, there is provided an echo removing apparatus including: a first echo removing device configured such that after admitting as input signals an output sound signal output from a speaker and a receiver sound signal transmitted from a calling party, the first echo removing device estimates a first pseudo echo component from the output sound signal in order to remove the first pseudo echo component from the receiver sound signal. The echo removing apparatus further includes: a synthesizing device configured to synthesize the output sound signal and the receiver sound signal rid of the first echo component by the first echo removing device into a composite sound signal, before outputting the composite sound signal; and a second echo removing device configured such that after admitting as input signals the composite sound signal output from the synthesizing device and a transmitter sound signal input from a microphone, the second echo removing device estimates a second pseudo echo component from the composite sound signal in order to remove the second pseudo echo component from the transmitter sound signal.

According to the present invention, echoes are not generated even if the same sound is being output near two calling parties' communication apparatuses, such as when both parties are watching the same TV program. This makes it possible for the two calling parties to hold a conversation agreeably while watching TV programs or doing other activities.

### BRIEF DESCRIPTION OF THE DRAWINGS

Further features and advantages of the present invention will become apparent upon a reading of the following description and appended drawings in which:

FIG. 1 is a block diagram showing a typical structure of videophone terminal equipment to which is applied an echo removing apparatus implemented as a first embodiment of the present invention;

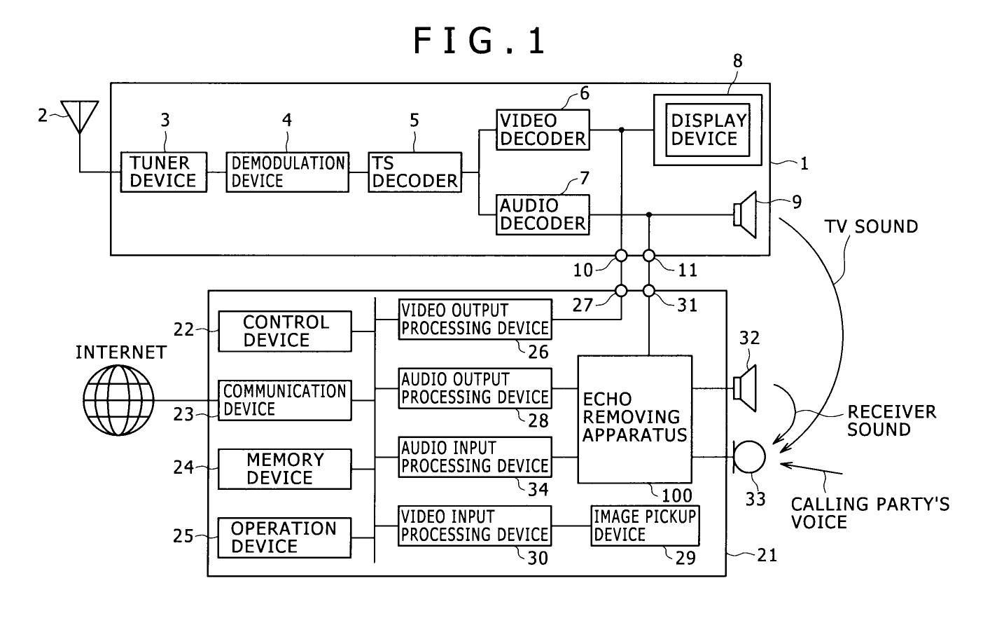

FIG. 2 is a block diagram showing a typical structure of the echo removing apparatus as the first embodiment of the invention;

FIG. 3 is a block diagram showing a variation of the first embodiment of the invention;

FIG. 4 is a block diagram showing another variation of the first embodiment of the invention;

FIG. 5 is a block diagram showing a typical structure of a personal computer to which is applied an echo removing apparatus implemented as a second embodiment of the present invention;

FIG. 6 is a block diagram showing a typical structure of a telephone terminal furnished with an ordinary echo canceller; and

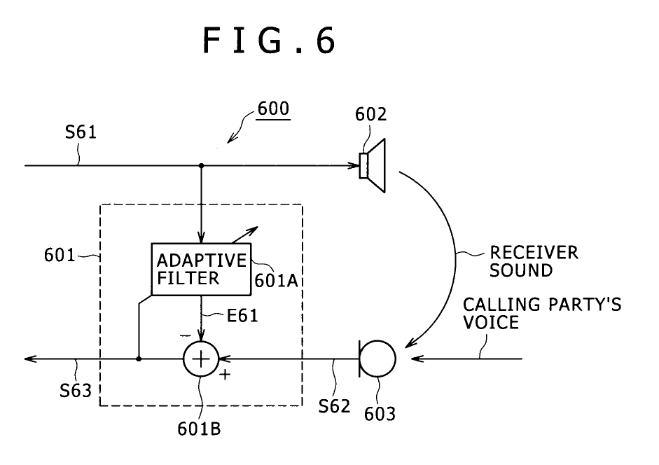

FIG. 7 is a block diagram showing a videophone system made up of telephone terminals each furnished with the ordinary echo canceller.

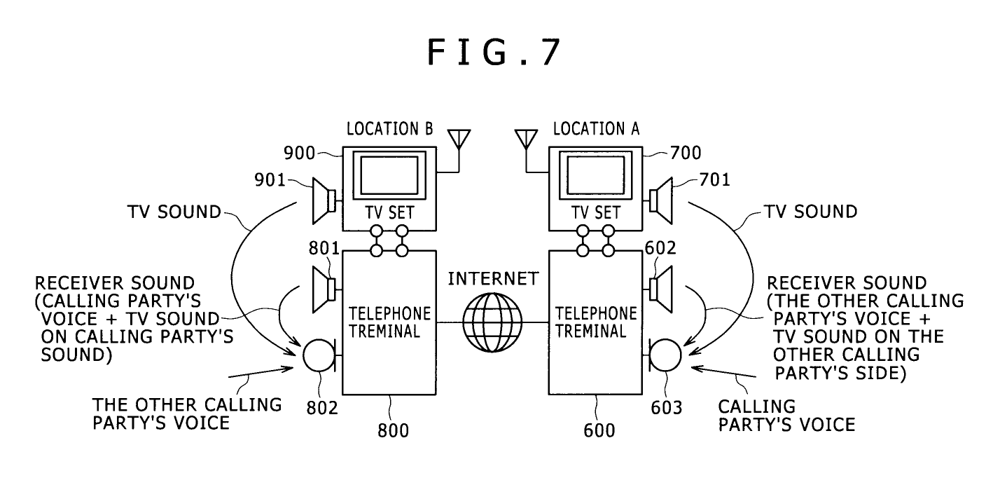

### DETAILED DESCRIPTION OF THE PREFERRED EMBODIMENTS

The preferred embodiments of the present invention will now be described in reference to the accompanying drawings. The description will be made under the following headings:

<1. First embodiment> (an example in which a TV set constituting videophone terminal equipment is housed in an enclosure separate from a telephone terminal)

<2. Second embodiment> (an example in which a personal computer constituting videophone terminal equipment is housed in the same enclosure as a communication apparatus)

### 1. First Embodiment

### [Structure of the Videophone Terminal Equipment]

Described below in detail with reference to the accompanying drawings is an example in which the present invention is applied to videophone terminal equipment as the first embodiment. With this embodiment, a TV set 1 acting as external equipment is housed in an enclosure separate from a telephone terminal 21.

The echo removing apparatus of the present invention is utilized illustratively when two calling parties hold a conversation through their videophones while watching the same TV program or playing the same online game or while their TV sets are otherwise outputting the same sound simultaneously. For the first embodiment, it is assumed that the two calling parties are holding a conversation while watching the same TV program. In the ensuing description, the person holding a conversation using the telephone terminal 21 will be called this calling party, and the person taking part in the conversation with this calling party will be referred to as the other calling party.

The TV set 1 is made up of an antenna 2, a tuner device 3, a demodulation device 4, a TS decoder 5, a video decoder 6, an audio decoder 7, a display device 8, a television (TV) speaker 9, a video input terminal 10, and an audio output terminal 11.

The broadcast wave of a terrestrial digital broadcast is received by the antenna 2. A received signal representative of the broadcast wave is fed from the antenna 2 to the tuner device 3 for conversion into an intermediate wave signal. The intermediate wave signal is supplied to the demodulation device 4 which demodulates the signal into a transport stream. The transport stream is sent to the TS decoder 5 that separates the transport stream into a video signal and an audio signal. The video signal output from the TS decoder 5 is decoded by the video decoder 6. The decoded video signal is displayed by the display device 8 such as a liquid crystal display (LCD) as a picture. The audio signal output from the TS decoder 5 is decoded by the audio decoder 7. The decoded audio signal is output by the TV speaker 9 as a TV sound.

The video input terminal 10 is connected to a video output terminal 27 of the telephone terminal 21, to be discussed later, by cable or the like. The audio output terminal 11 is connected to an audio input terminal 31 of the telephone terminal 21 by cable or the like. From the video output terminal 27 of the telephone terminal 21, the video input terminal 10 admits a video signal for displaying a picture of the other calling party. The audio output terminal 11 outputs a TV sound signal for use in echo removal to the audio input terminal 31 of the telephone terminal 21.

The telephone terminal 21 is made up of a control device 22, a communication device 23, a memory device 24, an operation device 25, a video output processing device 26, the video output terminal 27, an audio output processing device 28, an image pickup device 29, a video input processing device 30, and the audio input terminal 31. The telephone terminal 21 further includes a receiver speaker 32, a microphone 33, an audio input processing device 34, and an echo removing apparatus 100.

The control device 22 controls the components of the telephone terminal 21 and has control functions for implementing the videophone capability. The communication device 23 is connected to the Internet to conduct communications with the other calling party's videophone terminal equipment (not shown).

The memory device 24 retains programs and other software for use in conversations as well as various data including telephone numbers. The operation device 25 has diverse key switches including dial keys, button keys and a hook key. These key switches are operated by the user to input instructions to the telephone terminal 21.

The video output processing device 26 generates a video signal by processing the video data transmitted from the other calling party via the Internet and communication device 23, and outputs the generated video signal to the video output terminal 27. The video output terminal 27, connected to the video input terminal 10 of the TV set 1 by cable or the like, outputs the video signal coming from the video output processing device 26 to the TV set 1 through the video input terminal 10. When supplied with the video signal, the display device 8 displays the picture of the other calling party.

The audio output processing device 28 generates a receiver sound signal by performing such processing as D/A (digital to analog) conversion on the receiver sound data which comes from the other calling party's videophone terminal equipment and which is input over the Internet and through the communication device 23. The receiver sound signal thus generated is output from the audio output processing device 28 to the echo removing apparatus 100, to be discussed later. The receiver sound data coming from the other calling party is a mixture of the other calling party's voice and the sound of a TV program being output by the TV set established on the side of the other calling party.

The image pickup device 29 is composed of picture-taking lenses and an image sensor such as CCD (charge coupled device) or CMOS (complementary metal oxide semiconductor). Under instructions from the control device 22, the image pickup device 29 takes a picture of this calling party, converts the taken picture into video data, and outputs the data to the video input processing device 30. The video input processing device 30 performs such processing as white balance adjustment on the video data output from the image pickup device 29, and outputs the processed data to the communication device 23. In turn, the communication device 23 transmits the video data to the other calling party's videophone terminal equipment over the Internet.

The audio input terminal 31, connected to the audio output terminal 11 of the TV set 1 by cable or the like, outputs a TV sound signal to the echo removing apparatus 100, to be discussed later in detail.

The receiver speaker 32 receives the receiver sound signal output from the echo removing apparatus 100 and outputs the received signal as a receiver sound. The microphone 33 picks up and inputs this calling party's voice. The voice input to the microphone 33 is converted to a transmitter sound signal that is sent to the echo removing apparatus 100. The audio input processing device 34 generates transmitter audio data by performing such signal processing as A/D (analog to digital) conversion on the transmitter sound signal output from the echo removing apparatus 100, and outputs the generated transmitter audio data to the communication device 23. The communication device 23 transmits the transmitter sound data over the Internet to the other calling party's videophone terminal equipment. Upon receipt of the transmitter sound data, a speaker of the other calling party's videophone terminal equipment outputs this calling party's voice.

As described, the videophone terminal equipment is constituted by connecting the TV set 1 with the telephone terminal 21, the latter two being housed in a separate enclosure each. The majority of the telephone terminals constituting the videophone terminal equipment connected to the separate TV set are so-called set-top boxes. With the videophone terminal equipment of this structure, the other calling parity's picture is displayed on the display device 8 of the TV set 1. With this setup, it is possible to have a so-called picture-in-picture display in which the normal screen (parent screen) showing the picture of the TV program is overlaid with a smaller screen (child screen) indicating the other calling party's picture. Alternatively, the parent screen may be arranged to show the other calling party's picture, with the child screen displaying the TV program picture. As another alternative, a so-called picture-by-picture display may be provided wherein the picture of the TV program is displayed side by side with, and in the same size as, the other calling party's picture.

### [Structure of the Echo Removing Apparatus]

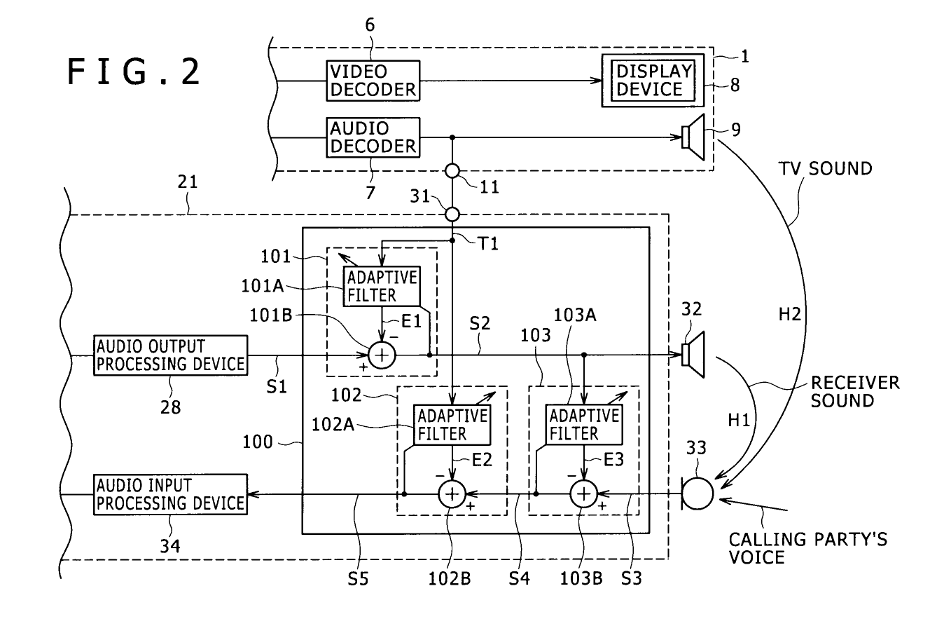

What follows is an explanation of a typical structure of the echo removing apparatus 100 installed in the telephone terminal 21. As shown in FIG. 2, the echo removing apparatus 100 includes three echo canceling devices: a first echo canceling device 101, a second echo canceling device 102, and a third echo canceling device 103. Each of the first through the third echo canceling devices 101 through 103 is made up of an adaptive filter 101A coupled with a subtractor 101B, an adaptive filter 102A with a subtractor 102B, and an adaptive filter 103A with a subtractor 103B. The first through the third echo canceling devices 101 through 103 are examples of the echo removing devices according to the present invention.

A television (TV) sound signal T1 is input to the adaptive filter 101A of the first echo canceling device 101 through the audio input terminal 31. The subtractor 101B admits a receiver sound signal S1 processed by the audio output processing device 28.

The receiver sound signal S1 is formed as a mixture of the other calling party's voice and the echo component generated when the TV sound output from the other calling party's TV set migrates to the same party's microphone. Thus if output as is from the receiver speaker 32, the receiver sound signal S1 would trigger echoes between the TV sound output from the TV speaker 9 of this calling party's TV set 1 and the same TV sound output from the receiver speaker 32, hampering a smooth conversation between the two parties. Taking advantage of the fact that the same TV sound is output from the TV sets of both calling parties, the first echo canceling device 101 removes the TV sound component of the other calling party from the receiver sound signal S1.

The adaptive filter 101A generates a pseudo echo signal E1 estimating the echo component based on the TV sound signal T1, and outputs the generated pseudo echo signal E1 to the subtractor 101B. By subtracting the pseudo echo signal E1 from the receiver sound signal S1, the subtractor 101B removes the TV sound component from the receiver sound signal S1 and outputs the result as a receiver sound signal S2. At this point, the receiver sound signal S2 rid of the echo component is input to the adaptive filter 101A as a remainder signal. The adaptive filter 101A detects an echo remainder from the remainder signal, learns to minimize the detected echo remainder, and updates its own filter coefficient so as to generate an ever-more appropriate pseudo echo signal E1.

The second echo canceling device 102 will be discussed later. What follows is an explanation of the third echo canceling device 103. The receiver sound signal S2 is input to the adaptive filter 103A of the third echo canceling device 103. A transmitter sound signal S3 from the microphone 33 is input to the subtractor 103B.

The transmitter sound signal S3 is formed as a mixture of this calling party's voice and the receiver sound output from the receiver speaker 32 and picked up by the microphone 33 by way of a spatial transmission path H1. The transmitter sound signal S3 is also mixed with the TV sound output from the TV speaker 9 and picked up by the microphone 33 by way of a spatial transmission path H2. Thus if output as is to the audio input processing device 34, the transmitter sound signal S3 would entail sending this calling party's voice and the receiver sound plus the TV sound. This would generate echoes on the side of the other calling party and hamper a smooth conversation between the two parties. The third echo canceling device 103 is thus intended to remove the receiver sound component from the transmitter sound signal S3.

The adaptive filter 103A generates a pseudo echo signal E3 estimating the echo component based on the receiver sound signal S2, and outputs the generated pseudo echo signal E3 to the subtractor 103B. By subtracting the pseudo echo signal E3 from the transmitter sound signal S3, the subtractor 103B removes the receiver sound component from the transmitter sound signal S3 and outputs the result as a transmitter sound signal S4. As with the adaptive filter 101A, the adaptive filter 103A detects the echo remainder from the remainder signal and learns to minimize the echo remainder so as to generate an ever-more appropriate pseudo echo signal E3.

The TV sound signal T1 is input to the adaptive filter 102A of the second echo canceling device 102. The transmitter sound signal S4 rid of the echo component by the third echo canceling device 103 is input to the subtractor 102B.

The transmitter sound signal S4 is formed as a mixture of this calling party's voice and the TV sound output from the TV speaker 9 and picked up by the microphone 33 by way of the spatial transmission path H2. Thus if output as is to the audio input processing device 34, the transmitter sound signal S4 would entail sending this calling party's voice and TV sound to the other calling party. Since the other calling party's TV set is outputting the same TV sound as the TV set 1 on the side of this calling party, echoes would be generated between the two calling parties and hamper a smooth conversation therebetween. By taking advantage of the fact that the same TV sound is output from the TV sets of both calling parties, the second echo canceling device 102 removes the TV sound component from the transmitter sound signal S4.

The adaptive filter 102A generates a pseudo echo signal E2 estimating the echo component based on the TV sound signal T1, and outputs the generated pseudo echo signal E2 to the subtractor 102B. By subtracting the pseudo echo signal E2 from the transmitter sound signal S4, the subtractor 102B removes the TV sound component from the transmitter sound signal S4 and outputs the result as a transmitter sound signal S5. As with the adaptive filter 101A, the adaptive filter 102A detects the echo remainder from the remainder signal and learns to generate an ever-more appropriate pseudo echo signal E2. The foregoing paragraphs have explained the typical structure of the echo removing apparatus 100.

### [Operation of the Echo Removing Apparatus]

How the echo removing apparatus 100 operates will now be explained.

When the other calling party starts communication using his or her videophone terminal equipment and begins to speak, the receiver sound signal S1 derived from conversion of the mixture of the other calling party's voice and the TV sound output from the other calling party's TV set is input to the subtractor 101B of the first echo canceling device 101. The TV sound signal T1 from the TV set 1 is input to the adaptive filter 101A of the first echo canceling device 101. The adaptive filter 101A then generates the pseudo echo signal E1 as described above. By subtracting the pseudo echo signal E1 from the receiver sound signal S1, the subtractor 101B generates and outputs the receiver sound signal S2 rid of the echo component.

The receiver sound signal S2 is output as the receiver sound from the receiver speaker 32. Since the other calling party's TV sound has been removed by the first echo canceling device 101, the receiver speaker 32 outputs only the other calling party's voice as the receiver sound. This allows this calling party to hear the voice of the other calling party clearly.

On the other hand, when this calling party starts speaking and inputs his or her voice to the microphone 33, the receiver sound output simultaneously from the receiver speaker 32 migrates to and is picked up by the microphone 33 by way of the spatial transmission path H1. Also, the TV sound output from the TV speaker 9 of the TV set 1 migrates to and is collected by the microphone 33 by way of the spatial transmission path H2.

The transmitter sound signal S3 that mixes the above three sounds is input to the subtractor 103B of the third echo canceling device 103. The receiver sound signal S2 is input to the adaptive filter 103A of the third echo canceling device 103. The adaptive filter 103A then generates the pseudo echo signal E3 as described above. By subtracting the pseudo echo signal E3 from the transmitter sound signal S3, the subtractor 103B generates and outputs the transmitter sound signal S4 rid of the receiver sound signal.

The transmitter sound signal S4 is then input to the subtractor 102B of the second echo canceling device 102. The TV sound signal T1 from the TV set 1 is input to the adaptive filter 102A of the second echo canceling device 102. The adaptive filter 102A then generates the pseudo echo signal E2 as discussed above. By subtracting the pseudo echo signal E2 from the transmitter sound signal S4, the subtractor 102B generates and outputs the transmitter sound signal S5 rid of the TV sound component.

The transmitter sound signal S5 is rid of both the receiver sound intruded via the spatial transmission path H1 and the TV sound that cut in via the spatial transmission path H2. Thus the other calling party's speaker outputs only this calling party's voice, so that the other calling party can hear this calling party's voice clearly.

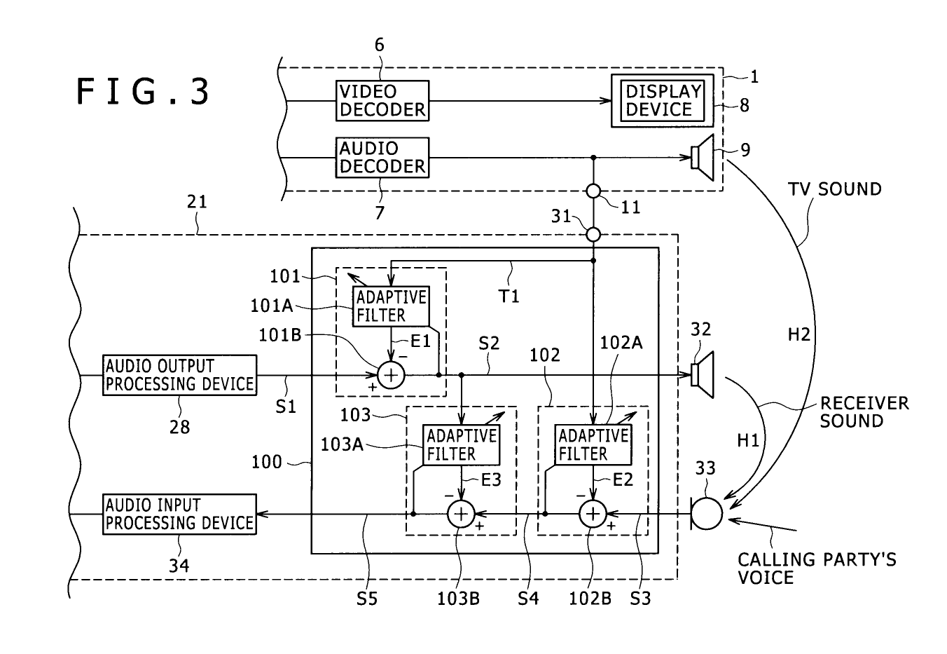

As one variation of the first embodiment of this invention, the second echo canceling device 102 may be positioned upstream of the third echo canceling device 103 as shown in FIG. 3. In this setup, the TV sound component is first removed from the transmitter sound signal S3.

Discussed so far is how the videophone terminal equipment is structured by connecting the TV set 1 with the telephone terminal 21. However, this is not limitative of the present invention. Alternatively, devices other than the TV set may be connected to the telephone terminal 21 instead. For example, any sound-emitting apparatus including such audio equipment as the radio set or component stereo, as well as the personal computer, DVD player, or hard disk player may be connected to the audio input terminal 31.

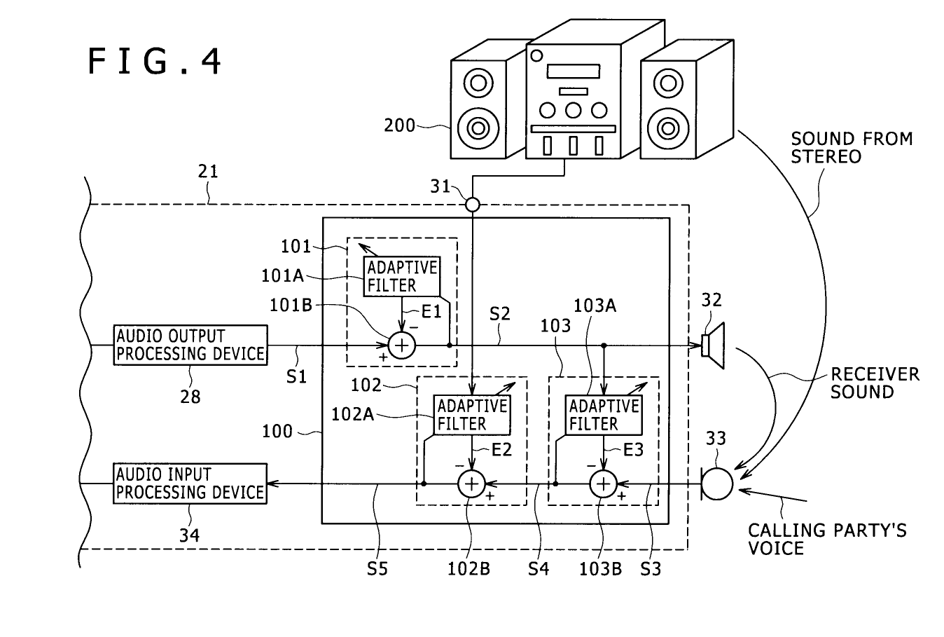

Suppose that as shown in FIG. 4, a component stereo 200 is set up in the same space as the telephone terminal 21. In this setup, the music or other sound output from the component stereo 200 is picked up by the microphone 33 and transmitted to the other calling party along with this calling party's voice. This will result in the other calling party's speaker outputting both the sound of the component stereo 200 and this calling party's voice, with the sound of the stereo 200 making it difficult for the other calling party to hear this calling party's voice clearly and thereby hamper a smooth conversation with the latter.

In order to bypass such eventuality, the component stereo 200 is connected to the audio input terminal 31 so that an output sound signal of the component stereo 200 is input to the second echo canceling device 102 of the echo removing apparatus 100. The connection enables the second echo canceling device 102 to remove the sound component of the component stereo 200 from the transmitter sound signal S4, allowing the other calling party to hear only this calling party's voice and thus hold a conversation agreeably with the latter. Since the sound that may be removed by the output sound signal of the component stereo 200 is not transmitted from the other calling party, there is no need to input any sound signal to the adaptive filter 101A of the first echo canceling device 101.

What is connectable to the audio input terminal 31 is not limited to the sound-emitting equipment. Audio input equipment such as the microphone may be connected to the audio input terminal 31 as well. Illustratively, suppose that trains pass by outside and the noise from the trains makes it difficult to hear voices and hold smooth conversations on the phone. In that case, a noise pickup microphone may be set up outdoors and connected to the audio input terminal 31 to send the noise from the passing trains to the echo removing apparatus 100. In turn, the echo removing apparatus 100 removes the noise component derived from the trains from the transmitter sound signal so as to transmit only the transmitter sound to the other calling party. In this manner, ambient noise or other sounds not desired to be sent to the other calling party may be picked up and input by a noise pickup microphone so that the undesirable noises may be eliminated to permit clearly audible conversations between the two calling parties.

### 2. Second Embodiment

### [Structures of the Personal Computer and Echo Removing Apparatus]

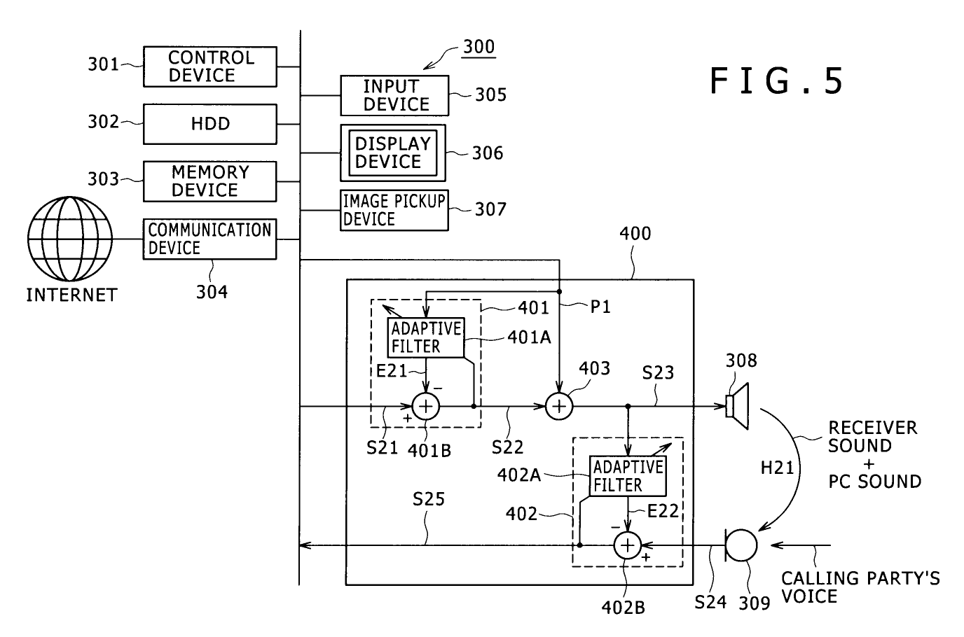

Described below in detail with reference to FIG. 5 in particular is how the invention is applied to the personal computer as the second embodiment. In the second embodiment, one speaker doubles as a receiver speaker and a speaker for outputting the sound of a personal computer (called the PC sound hereunder). It is assumed here that two calling parties talk to each other through the videophone function of their PCs and that they are playing the same online game together.

A personal computer 300 includes a control device 301, a hard disk drive (HDD) 302, a memory device 303, a communication device 304, an input device 305, a display device 306, an image pickup device 307, a speaker 308, a microphone 309, and an echo removing apparatus 400.

The control device 301 controls the components of the personal computer 300. The HDD 302 retains the operating system and other diverse kinds of software including one for implementing the videophone capability on the personal computer. The memory device 303 is used by the control device 301 as a work area. The communication device 304 is connected to the Internet and communicates with the other calling party's personal computer (not shown) via the Internet. The input device 305 includes various means of input such as a keyboard and a mouse. The input device 305 is operated by the user to input instructions to the personal computer 300.

The display device 306 serves as a display that shows diverse pictures including those of online games and the other calling party's picture. the other calling party's picture transmitted from that party's personal computer is received by the communication device 304 via the Internet. The received picture is processed under control of the control device 301 before being displayed on the display device 306. During this time, the picture of the same online game played by the two calling parties is being displayed together with the parties' own pictures in the picture-in-picture or picture-by-picture format.

The image pickup device 307 is illustratively a camera mounted on top of the display device 306. The picture taken by the image pickup device 307 is converted to a video signal under control of the control device 301. The video signal is then transmitted to the other calling party's personal computer through the communication device 304 and over the Internet.

The receiver sound data transmitted from the other calling party's personal computer is received by the communication device 304. The receiver sound data thus received is processed by the control device 301 and converted to a receiver sound signal S21. Thereafter, the receiver sound signal S21 is subjected to the echo removing process performed by the echo removing apparatus 400. The receiver sound signal S22 thus processed is output as the receiver sound by the speaker 308. The speaker 308 simultaneously outputs the sound of the online game being played on the personal computer. The speaker 308 doubles as the receiver speaker and the speaker for outputting the PC sound. The voice input by this calling party to the microphone 309 is converted to a transmitter sound signal S24 which in turn is subjected to the echo removing process carried out by the echo removing apparatus 400. The transmitter sound signal S24 is then converted to transmitter sound data by the control device 301. The transmitter sound data is transmitted by the communication device 304 to the other calling party's personal computer.

The echo removing apparatus 400 includes a first echo canceling device 401 and a second echo canceling device 402. The structure of the echo canceling devices is the same as that of the first embodiment. In the second embodiment, the echo removing apparatus 400 also includes a synthesizing device 403. As will be discussed later in more detail, the synthesizing device 403 synthesizes the output of the first echo canceling device 401 with the PC sound.

### [Operation of the Echo Removing Apparatus]

How the echo removing apparatus 400 operates will now be described.

If the two calling parties talk to each other while playing an online game together on the Internet, a PC sound signal P1 is input to an adaptive filter 401A of the first echo canceling device 401. The receiver sound signal S21 is input to a subtractor 401B of the first echo canceling device 401.

The receiver sound signal S21 is formed as a mixture of the other calling party's voice and the echo component generated when the PC sound output from the other calling party's personal computer migrates to the same party's microphone. Thus if output as is from the receiver speaker 308, the receiver sound signal S21 would trigger echoes between the PC sound output from this calling party's personal computer and the same PC sound output from the speaker 308, hampering a smooth conversation between the two parties. Taking advantage of the fact that the same PC sound is output from the personal computers of both calling parties, the first echo canceling device 401 removes the PC sound component of the other calling party from the receiver sound signal S21.

The adaptive filter 401A generates a pseudo echo signal E21 estimating the echo component based on the PC sound signal P1, and outputs the generated pseudo echo signal E21 to the subtractor 401B. By subtracting the pseudo echo signal E21 from the receiver sound signal S21, the subtractor 401B removes the PC sound component from the receiver sound signal S21 and outputs the result as a receiver sound signal S22. At this time, as with the first embodiment, the adaptive filter 401A detects the echo remainder from the remainder signal and learns to minimize the detected echo remainder so as to generate an ever-more appropriate pseudo echo signal E21.

The receiver sound signal S22 output from the first echo canceling device 401 is then input to the synthesizing device 403. The PC sound signal P1 is also input to the synthesizing device 403. The synthesizing device 403 proceeds to synthesize the receiver sound signal S22 with the PC sound signal P1 and outputs the result as a composite sound signal S23.

The composite sound signal S23 is then sent to the speaker 308. The speaker 308 outputs both the other calling party's voice as the receiver sound and the sound of this calling party's personal computer. Since the other calling party's PC sound component has been removed by the first echo canceling device 401, there are no echoes generated between the other calling party's PC sound and this calling party's PC sound. This allows each of the two calling parties to hear the other party's voice clearly while enjoying the online game being played together.

On the other hand, when this calling party starts speaking and inputs his or her voice to the microphone 309, the receiver sound and PC sound output simultaneously from the speaker 308 migrates to and is picked up by the microphone 309 by way of a spatial transmission path H21. The transmitter sound signal S24 that mixes these three sounds is input to a subtractor 402B of the second echo canceling device 402. The composite sound signal S23 is input to an adaptive filter 402A of the second echo canceling device 402. The adaptive filter 402A then generates the pseudo echo signal E22 as described above. By subtracting the pseudo echo signal E22 from the transmitter sound signal S24, the subtractor 402B generates and outputs a transmitter sound signal S25 rid of the receiver sound component and PC sound component.

The transmitter sound signal S25 thus output is processed by the control device 301 before being transmitted by the communication device 304 to the other calling party's personal computer. The transmitter sound signal S25 is then output by the speaker of the other calling party's personal computer as a sound. Since the transmitter sound signal S25 is rid of both the receiver sound and the PC sound intruded via the spatial transmission path H21, there are no echoes generated on the side of the other calling party. This allows the other calling party to hear both this calling party's voice and the sound of the online game clearly.

It is to be understood that while the invention has been described in conjunction with specific embodiments with reference to the accompanying drawings, it is evident that many alternatives, modifications and variations will become apparent to those skilled in the art in light of the foregoing description. It is thus intended that the present invention embrace all such alternatives, modifications and variations as fall within the spirit and scope of the appended claims. For example, the present invention may be applied not only to household videophone systems but also to teleconference systems using videophones. The present invention may also be utilized not only where an online game is being played on PCs but also where an Internet TV program is being watched using PC-based telephone services such as Skype (registered trademark).

If one calling party alone uses the telephone terminal furnished with the echo removing apparatus of the present invention while the other calling party does not utilize the inventive apparatus, it is still possible for the two calling parties to hold a clearly audible conversation therebetween. However, there could remain some echo component in the receiver sound signal and transmitter sound signal. The two calling parties can hold the conversation more clearly if they both make use of the echo removing apparatus of the present invention. In this setup, the TV sound component is removed from the transmitter sound signal on the side of this calling party while the TV sound component is also removed from the transmitter sound signal from the other calling party. This setup ensures more reliable removal of the echo component than ever.

The present application contains subject matter related to that disclosed in Japanese Priority Patent Application JP 2009-108950 filed in the Japan Patent Office on Apr. 28, 2009, the entire content of which is hereby incorporated by reference.

What is claimed is:

1. An echo removing apparatus comprising:
a sound input terminal configured to input an external sound signal from external equipment;
first echo removing means for, after admitting as input signals said external sound signal coming from said external equipment and input through said sound input terminal and a receiver sound signal transmitted from a calling party, estimating a first pseudo echo component from said external sound signal in order to remove said first pseudo echo component from said receiver sound signal; and
second echo removing means for, after admitting as input signals said external sound signal coming from said external equipment and input through said sound input terminal and a transmitter sound signal input from a microphone, estimating a second pseudo echo component from said external sound signal in order to remove said second pseudo echo component from said transmitter sound signal.

2. The echo removing apparatus according to claim 1, further comprising
third echo removing means for estimating a third pseudo echo component from said receiver sound signal rid of said first pseudo echo component by said first echo removing means, before removing said third pseudo echo component from said transmitter sound signal.

3. The echo removing apparatus according to claim 1, wherein said external equipment is a television set.

4. The echo removing apparatus according to claim 1, wherein said external equipment is audio equipment.

5. The echo removing apparatus according to claim 1, wherein said external equipment is a microphone.

6. An echo removing apparatus comprising:
first echo removing means for, after admitting as input signals an output sound signal output from a speaker and a receiver sound signal transmitted from a calling party, estimating a first pseudo echo component from said output sound signal in order to remove said first pseudo echo component from said receiver sound signal;
synthesizing means for synthesizing said output sound signal and said receiver sound signal rid of said first echo component by said first echo removing means into a composite sound signal, before outputting said composite sound signal; and
second echo removing means for, after admitting as input signals said composite sound signal output from said synthesizing means and a transmitter sound signal input from a microphone, estimating a second pseudo echo component from said composite sound signal in order to remove said second pseudo echo component from said transmitter sound signal.

7. An echo removing method comprising the steps of:
inputting an external sound signal from external equipment;
after admitting as input signals said external sound signal coming from said external equipment and input through said sound input terminal and a receiver sound signal transmitted from a calling party, estimating a first pseudo echo component from said external sound signal in order to remove said first pseudo echo component from said receiver sound signal; and
after admitting as input signals said external sound signal coming from said external equipment and input in the sound inputting step and a transmitter sound signal input from a microphone, estimating a second pseudo echo component from said external sound signal in order to remove said second pseudo echo component from said transmitter sound signal.

8. An echo removing method comprising the steps of:
after admitting as input signals an output sound signal output from a speaker and a receiver sound signal transmitted from a calling party, estimating a first pseudo echo component from said output sound signal in order to remove said first pseudo echo component from said receiver sound signal;
synthesizing said output sound signal and said receiver sound signal rid of said first echo component in the first echo removing step into a composite sound signal, before outputting said composite sound signal; and
after admitting as input signals said composite sound signal output in the synthesizing step and a transmitter sound signal input from a microphone, estimating a second pseudo echo component from said composite sound signal in order to remove said second pseudo echo component from said transmitter sound signal.

9. A communication apparatus comprising:
a sound input terminal configured to input an external sound signal from external equipment;
first echo removing means for, after admitting as input signals said external sound signal coming from said external equipment and input through said sound input terminal and a receiver sound signal transmitted from a calling party, estimating a first pseudo echo component from said external sound signal in order to remove said first pseudo echo component from said receiver sound signal;
a speaker configured to output as a receiver sound said receiver sound signal rid of said first pseudo echo component by said first echo removing means;
a microphone configured to input a transmitter sound signal to be transmitted to said calling party;
second echo removing means for, after admitting as input signals said external sound signal coming from said external equipment and input through said sound input terminal and said transmitter sound signal input from said microphone, estimating a second pseudo echo component from said external sound signal in order to remove said second pseudo echo component from said transmitter sound signal; and
a network interface configured to connect with a network.

10. A communication apparatus comprising:
first echo removing means for, after admitting as input signals an output sound signal output from a speaker and a receiver sound signal transmitted from a calling party, estimating a first pseudo echo component from said output sound signal in order to remove said first pseudo echo component from said receiver sound signal;
synthesizing means for synthesizing said output sound signal and said receiver sound signal rid of said first echo component by said first echo removing means into a composite sound signal, before outputting said composite sound signal;
a speaker configured to output as a sound said composite sound signal output from said synthesizing means;
a microphone configured to input a transmitter sound signal to be transmitted to said calling party;
second echo removing means for, after admitting as input signals said composite sound signal output from said synthesizing means and said transmitter sound signal input from said microphone, estimating a second pseudo echo component from said composite sound signal in order to remove said second pseudo echo component from said transmitter sound signal; and
a network interface configured to connect with a network.

11. An echo removing apparatus comprising:
a sound input terminal configured to input an external sound signal from external equipment; and
echo removing means for, after admitting as input signals said external sound signal coming from said external equipment and input through said sound input terminal and a receiver sound signal transmitted from a calling party, estimating a pseudo echo component from said external sound signal in order to remove said pseudo echo component from said receiver sound signal.

12. An echo removing apparatus comprising:
a sound input terminal configured to input an external sound signal from external equipment; and
echo removing means for, after admitting as input signals said external sound signal coming from said external equipment and input through said sound input terminal and a transmitter sound signal input from a microphone, estimating a pseudo echo component from said external sound signal in order to remove said pseudo echo component from said transmitter sound signal.

13. An echo removing apparatus comprising:
a first echo removing device configured such that after admitting as input signals an output sound signal output from a speaker and a receiver sound signal transmitted from a calling party, said first echo removing device estimates a first pseudo echo component from said output sound signal in order to remove said first pseudo echo component from said receiver sound signal;
a synthesizing device configured to synthesize said output sound signal and said receiver sound signal rid of said first echo component by said first echo removing device into a composite sound signal, before outputting said composite sound signal; and
a second echo removing device configured such that after admitting as input signals said composite sound signal output from said synthesizing device and a transmitter sound signal input from a microphone, said second echo removing device estimates a second pseudo echo component from said composite sound signal in order to remove said second pseudo echo component from said transmitter sound signal.
